(19) United States
(12) Patent Application Publication
(10) Pub. No.: US 2026/0191708 A1
(43) Pub. Date: Jul. 9, 2026

(54) ECOSYSTEM OF INTERCHANGEABLE MEDICAL MODULES DEPLOYABLE ON A SYSTEMIC CHASSIS

(71) Applicants: Justin Schultz, Winston-Salem, NC (US); Neil Rotroff, Winston-Salem, NC (US); Aaron Reed, Greensboro, NC (US); Travis Lefever, Jamestown, NC (US)

(72) Inventors: Justin Schultz, Winston-Salem, NC (US); Neil Rotroff, Winston-Salem, NC (US); Aaron Reed, Greensboro, NC (US); Travis Lefever, Jamestown, NC (US)

(21) Appl. No.: 19/009,400

(22) Filed: Jan. 3, 2025

(51) Int. Cl. A61G 3/00; B60P 3/14; B62D 63/02; G06Q 30/04

(52) U.S. Cl. CPC A61G 3/001; B60P 3/14; B62D 63/025; G06Q 30/04

(57) ABSTRACT

An ecosystem of interchangeable medical modules selectively deployed on a systemic platform, wherein the systemic platform provides a chassis supporting a front end and a rear end of a mobile medical system. The rear and front end are supported in a spaced apart arrangement so that one of the plurality of modules can be removable joined to the chassis and thereby to the front and rear ends.

### BACKGROUND OF THE SUBJECT DISCLOSURE

The present subject disclosure relates to mobile medical facilities and, more particularly, to an ecosystem of interchangeable medical modules deployable on a systemic chassis.

Rural areas have a dispersed and remote population that would seem to make mobile medical services very attractive. Current mobile health units, however, are built as custom specialty vehicles for single use cases since government grants typically encourage or require health systems to purchase such vehicles (through, in some cases, requiring the purchaser to own them, like fleet vehicles).

This requirement is short-sighted and, when combined with the following limitations, causes low adoption rates in the mobile health space. First, the return on investment for single-use medical vehicles is minimal due to each unit's limited use in view of the distributed demand and confined geography of their deployment, which results in low utilization and outsized operational losses. Second, custom commercial vehicles pose unique challenges for fleet maintainers, including but not limited to minor mechanical issues resulting in costly service interruptions because the one-off nature of the vehicle presents the fleet maintainers with sui generis maintenance issues as opposed to well-known problems that are correctable through commonplace solutions.

As a result, mobile programs tend to flounder with the knock-on effect being that decisionmakers perceive the risks of mobile medicine outweighing the rewards, whereby caution crowds out courage (in general) and adoption is limited.

As can be seen, there is a need for a pay-per-use ecosystem of swappable medical suites, each medical suite selectively deployable on an electric vehicle (EV) chassis based on situational need.

### SUMMARY OF THE SUBJECT DISCLOSURE

The mobile medical delivery systems embodied by the subject disclosure enable a flexible healthcare system which improves the financial feasibility of community care, especially for rural hospitals. Instead of inextricably fixing a chassis to a single-function space for supporting only a single or limited use case, which users must purchase and use in a figurative silo, such that the prior art is anchored to; in contrast, the subject disclosure enables an ecosystem offering medical service providers decision-making power to choose which of a plurality of multi-functional spaces to removably couple to a multi-functional chassis for selectively meeting patients'needs. As a result, the design of the subject disclosure provides a single versatile chassis that supports one of a plurality of mobile medical facilities (“suites”or “modules”) , thereby discrete medical providers need only commit to one such chassis, which in turn allows these medical providers to purchase shared access and use in a network of medical providers, thereby reducing the aforementioned risk, and so expanding the availability of medical care in rural communities.

An ability to swap fully medical suites “on the fly”, in minutes, via safe and simple rail/roller fixtures enables medical providers selectively outfit the systemic chassis with the preferred medical suite from a myriad of offered suites. This drastically expands the breadth and quality of care available to rural counties. A switching station providing a plurality of swappable medical suites, each suite with reception and waiting areas, facilitates placing advanced diagnostic equipment purchased for community health into regular rotation in a hospital's space scheduling system. This facilitates optimal utilization of available equipment across a series of otherwise remote medical providers.

The subject matter disclosure further enables a pay-per-use business model deployed by rural locations via mobile transport, uniquely supporting exponential adoption, thereby advancing health services to remote communities in the following ways: a) creating flexibility in care delivery wherein health systems can deliver exactly the care and diagnostics required without investing in multiple transport mechanisms; b) improving the financial feasibility of distributed community care through optimal utilization of expensive medical devices (e.g., imaging devices) in contrast to the inherent risk of the prior art laboring to support use of permanently anchored equipment; c) increasing collaboration and risk sharing as investments are shared across systems; and d) increasing overall profit from increased patient access (soft revenue). At its core the subject disclosure is designed to advance health equity.

In one aspect of the subject disclosure, a system for providing a pay-per-use ecosystem of interchangeable mobile medical modules includes a chassis configured to removably receive one of a plurality of the mobile medical modules, wherein each mobile medical module has structural framework defining an enclosure separate from chassis, and wherein each mobile medical module is outfitted as a medical suite; and the chassis configured to support a front end and a rear end in a spaced apart arrangement, thereby defining a module space therebetween, wherein each of the plurality of the mobile medical modules occupies the module space when in use.

In another aspect of the subject disclosure, the system for providing a pay-per-use ecosystem of interchangeable mobile medical modules further includes the following: wherein each of the plurality of the mobile medical modules provides different analytic, diagnostic and treatment equipment to meet distinct and different medical conditions relative to the remaining mobile medical modules of the plurality of the mobile medical modules, wherein each of the plurality of the mobile medical modules has an enclosure providing one or two gateways communicable with the front end or the rear end, wherein the rear end is dimensioned and shaped to provide a reception area or waiting area communicable with the one or two gateways, wherein the chassis further includes a front wheel assembly disposed near the front end; a rear wheel assembly disposed near the rear end; and a power source operable to power to wheel assemblies, wherein the front end includes control assemblies for controlling direction and motive force of the wheel assemblies; the chassis includes a chassis frame defining the lowest point of the module space, wherein the chassis frame comprises a plurality of chassis members having at least one rail feature and at least one roller feature along an upper surface of the chassis frame, wherein the rail and roller features facilitate the interchangeability of the plurality of the mobile medical modules; further including a scissor lift to further facilitate the interchangeability of the plurality of the mobile medical modules; and further including a switching station providing the scissor lift.

These and other features, aspects and advantages of the present subject disclosure will become better understood with reference to the following drawings, description and claims.

### BRIEF DESCRIPTION OF THE DRAWINGS

FIG. 1 is a perspective view of an exemplary embodiment of the subject disclosure.

FIG. 2 is a perspective view of an exemplary embodiment of the subject disclosure with the interior of a front end 120, a module 200, and a rear end 130 visible in dashed lines.

FIG. 3 is a schematic view of an exemplary embodiment of the subject disclosure, illustrating the interchangeability of the modular medical suites.

FIG. 4 is a perspective view of an exemplary embodiment of a chassis member 150 of the subject disclosure.

FIG. 5 is a perspective view of an exemplary embodiment of a chassis frame 160 of the subject disclosure.

FIG. 6 is a perspective view of an exemplary embodiment of the chassis frame 160 of the subject disclosure, illustrating roller features.

FIG. 7 is a perspective view of an exemplary embodiment of a scissor lift 300 of the subject disclosure.

FIG. 8 is a schematic view of an exemplary embodiment of a module weather sealing system of the subject disclosure.

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

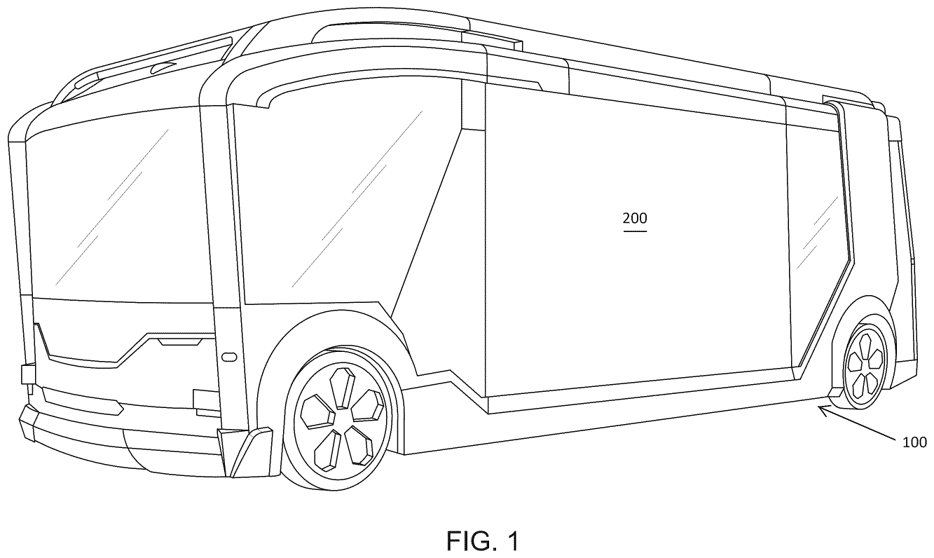

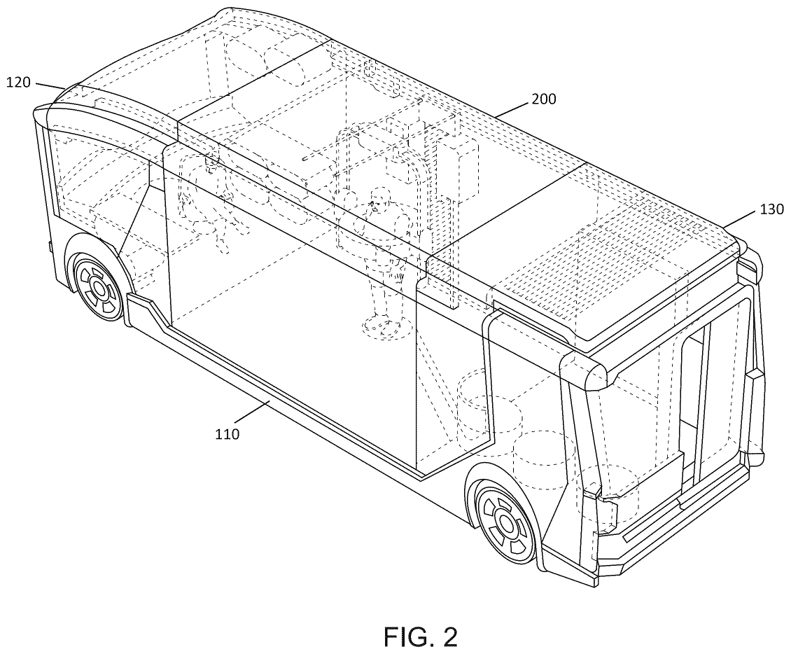

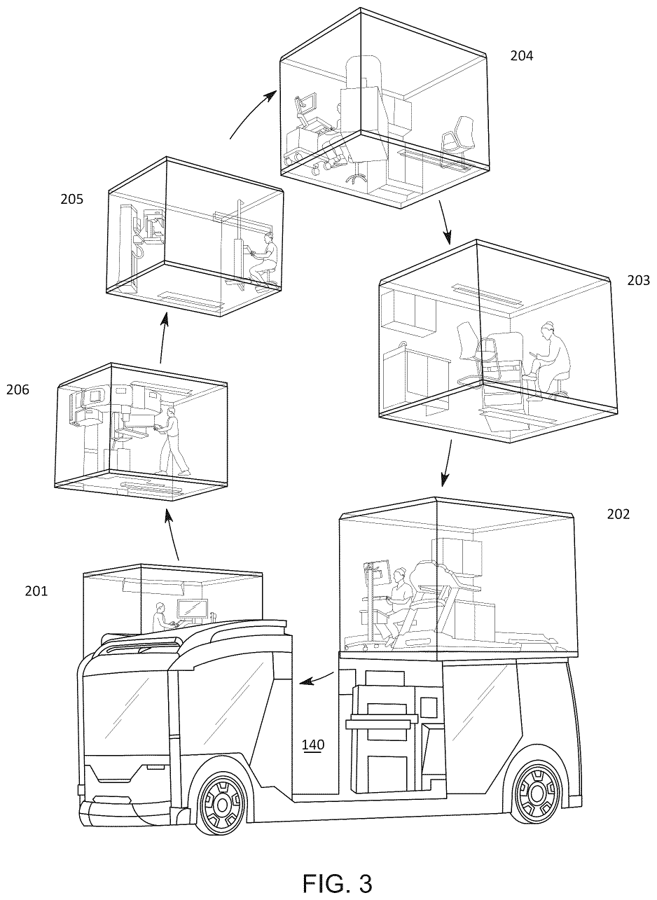

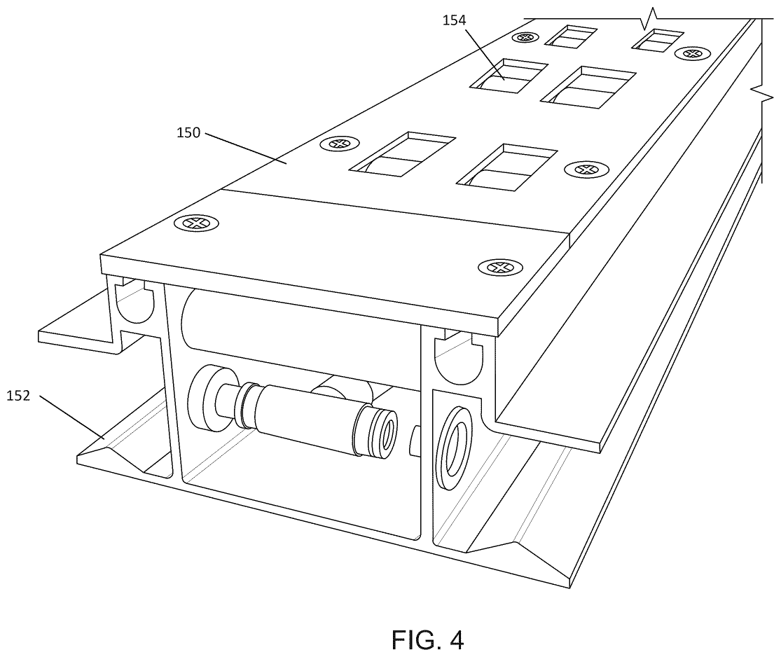

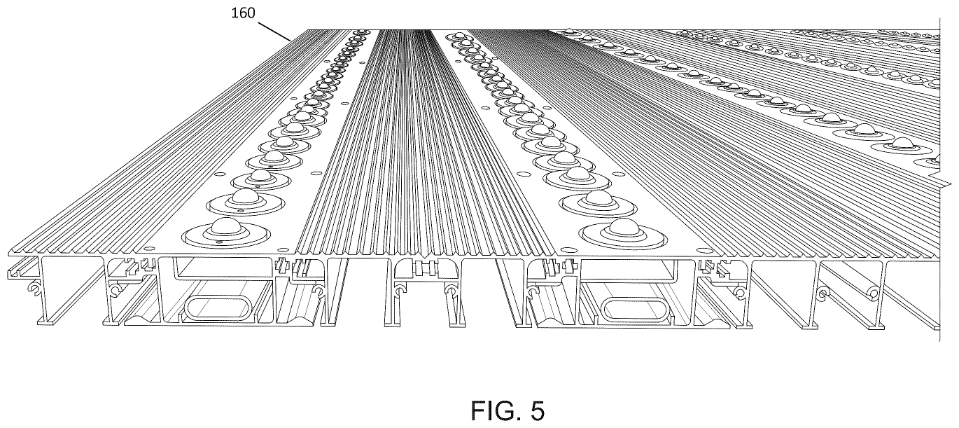

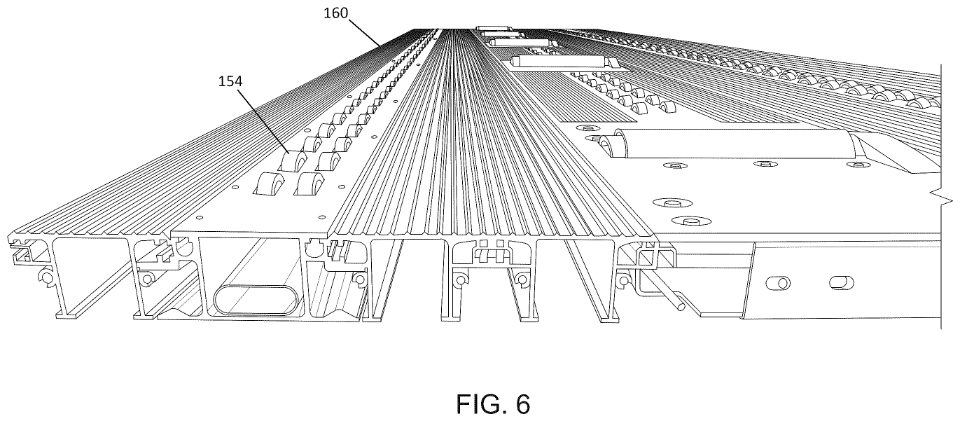

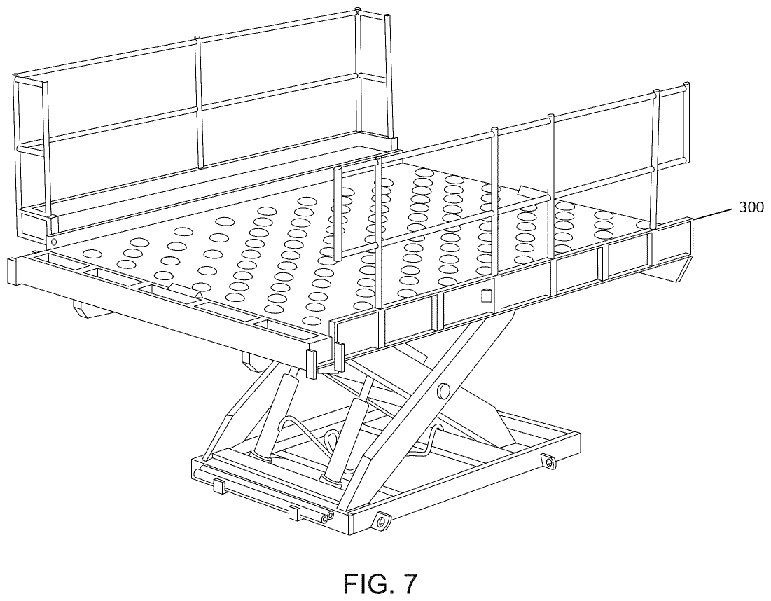

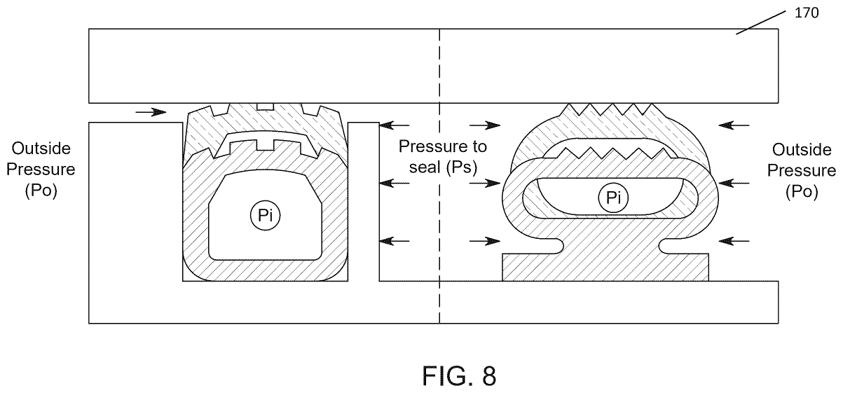

Referring to FIGS. 1 through 8, the subject disclosure includes a medical delivery ecosystem providing a systemic “skateboard” automotive or electric vehicle platform 100 which embodies a chassis 110 configured to removably receive one of a plurality of modules 200, wherein each module 200 are outfitted as a medical suite. The ecosystem contemplates a switching station (not shown) configured to selectively place a first module 200 on the systemic platform 100 and subsequently remove the first module 201 from the systemic platform 100 to replace it with a second module 202. The switching station warehouse stores said plurality of modules 200 so that a plurality of systemic platform 100 can be served, thereby improving the financial feasibility of distributed community care (wherein each remote community uses a dedicated systemic platform 100) through full utilization of expensive medical devices, enhancing collaboration and risk sharing as investments are shared across a system of distributed communities, and advancing health equity.

The systemic platform 100 may define a chassis 110 supporting a front end 120 and a rear end 130 in a spaced apart arrangement so as to define a module space 140 therebetween. The chassis 110 provides a front wheel assembly disposed near the front end 120, a rear wheel assembly disposed near the rear end 130, and a power source operable to power to wheel assemblies. The front end 120 provides control assemblies for controlling the direction and motive force of the wheel assemblies. The rear end 130 may be dimensioned and adapted to provide a reception/admin area, examination areas, and waiting area. The module space is configured to removably receive and engage with a selected module 200.

Each module 200 has a structural framework defining an enclosure separate from the systemic platform 100, wherein the enclosure houses a plurality of specialty medical equipment. Each module 200 may provide medical equipment tailored and certified to treat a genus of medical conditions. Accordingly, among the plurality of modules 200, different modules 200 provide different analytic, diagnostic and treatment equipment to meet the divergent challenges of distinct and different medical conditions. The enclosure provides one or two gateways communicable with the front end 120 or the rear end 130, respectively. The enclosures may be repeatably prefabricated and then outfitted with the desired medical equipment.

A scissor lift 300 or other lifting apparatus may be used to remove and place modules 200 within the module space 140 on the frame 160 of the chassis 110. The frame 160 may be an amalgamation of the chassis members 150, which provide rail features 152 and roller features 154 to facilitate loading and removing the module 200 to and from the module space 140 in a quick and safe interchangeable manner.

In other words, the subject disclosure provides flexibility in deploying various healthcare clinical services to rural or urban populations through a specially designed facility designed for and constructed on an outparcel at a rural hospital or independent location, outfitted to receive the prefabricated modules 200, which allows modules and their interior equipment/supplies to be seamlessly integrated into a health system's existing room-scheduling protocols.

The ecosystem synthesizes patient density at an affordable cost and provides rural hospitals access to resource leveling for specialty medical equipment between sparse and dense populations. The subject disclosure enables the integration of mobile medical clinics on the systemic platform 100 so that the modular medical suites containing specialty medical equipment.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. A system for providing a pay-per-use ecosystem of interchangeable mobile medical modules, the system comprising:
a chassis configured to removably receive one of a plurality of the mobile medical modules, wherein each mobile medical module has structural framework defining an enclosure separate from chassis, and wherein each mobile medical module is outfitted as a medical suite; and
the chassis configured to support a front end and a rear end in a spaced apart arrangement, thereby defining a module space therebetween, wherein each of the plurality of the mobile medical modules occupies the module space when in use.

2. The system of claim 1, wherein each of the plurality of the mobile medical modules provides different analytic, diagnostic and treatment equipment to meet distinct and different medical conditions relative to the remaining mobile medical modules of the plurality of the mobile medical modules.

3. The system of claim 2, wherein each of the plurality of the mobile medical modules has an enclosure providing one or two gateways communicable with the front end or the rear end.

4. The system of claim 3, wherein the rear end is dimensioned and shaped to provide a reception area or waiting area communicable with the one or two gateways.

5. The system of claim 4, wherein the chassis further comprises:
a front wheel assembly disposed near the front end;
a rear wheel assembly disposed near the rear end; and
a power source operable to power to wheel assemblies.

6. The system of claim 5, wherein the front end comprises control assemblies for controlling direction and motive force of the wheel assemblies.

7. The system of claim 6, wherein the chassis comprises a chassis frame defining the lowest point of the module space.

8. The system of claim 7, wherein the chassis frame comprises a plurality of chassis members having at least one rail feature and at least one roller feature along an upper surface of the chassis frame, wherein the rail and roller features facilitate the interchangeability of the plurality of the mobile medical modules.

9. The system of claim 8, further comprising a scissor lift to further facilitate the interchangeability of the plurality of the mobile medical modules.

10. The system of claim 9, further comprising a switching station providing the scissor lift.
